(19) United States
(12) Patent Application Publication
(10) Pub. No.: US 2010/0114609 A1
(43) Pub. Date: May 6, 2010

(54) System and method for medical report generation

(76) Inventors: Kevin James Duffy, JR., Philadelphia, PA (US); Craig Hilbert Scott, Charlottesville, VA (US); Jonathan Choate Bishop, Philadelphia, PA (US)

Correspondence Address: WHITE-WELKER & WELKER, LLC, P.O. BOX 199, CLEAR SPRING, MD, 21722-0199, US

(21) Appl. No.: 12/609,094

(22) Filed: Oct. 30, 2009

Related U.S. Application Data
(60) Provisional application No. 61/109,814, filed on Oct. 30, 2008.

(51) Int. Cl. G06Q 50/00

(52) U.S. Cl. 705/3

(57) ABSTRACT

The present invention is a fully HIPAA and standards-compliant web-based reporting tool built by and for physicians to produce medical reports quickly and easily. The present invention comes with numerous reporting applications and can work independently or be embedded into other applications. A user can change applications to fit their workflow by adding or removing form objects, adjusting the display layout, changing error checking or business logic or changing the structure of the final report all without traditional programming. A user could start from scratch to build out a new application. The present invention interfaces with existing systems, provides a structured workflow, contains many advanced features that allow the user to review results and make changes before creating a structured report. A comparison feature examines data from previous reports and automatically displays clinically important changes into the new report. Quality assurance assessments, billing and statistical reporting can also be performed.

### CROSS REFERENCE TO RELATED APPLICATIONS

This application claims priority from U.S. Provisional Patent Application Ser. No. 61/109,814, entitled “A system and method for medical report generation”, filed on 30 Oct. 2008. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a method for report generation. More specifically, the present invention relates to a method for medical report generation and controlling access to different individuals utilizing the same data set in an electronic environment through the use of the customizable forms.

### BACKGROUND OF THE INVENTION

There are many methods known in the prior art for generating reports. The present invention improves upon the known methods and systems by teaching a report generation method that lowers costs, boosts productivity and saves physicians time by providing physicians access to an efficient, easy to use reporting system ultimately delivering higher quality service more profitably.

The present invention is a technology solution that simplifies the documentation process and eliminates the need for transcription and dictation services, which can take days or weeks until critical patient information is available for follow-up treatment and billing purposes.

The present invention increases the speed of data entry, improves the accuracy of reports, streamlines work flow and delivers grammatically correct clinical reports quickly and easily. The present invention takes the user's input and, based on predefined sentence structuring algorithms and stored phrases, constructs a report with excellent readability.

Unlike the systems known in the prior art, the user interface and reports generated by the present invention make it ideal for use by non-technical audiences while a powerful feature set extends control over every aspect of a reporting application. The system was developed by physicians for physicians. As a result, the system requires little training and provides a powerful interface which can be modified by the user to change format, content and report output. The system has been proven to make physicians more efficient and at the same time improve report quality.

Many programs utilize methods to control access to different individuals utilizing the same data set, most commonly by restricting access to certain forms or parts of a user interface or controlling each field to allow or deny access to the data (field is grayed out, commonly).

The present invention teaches a new method to control user access made possible through the design of a customizable user interface (UI) in the present invention called a view. There is one common set of data for an application, but, unlike traditional methods which are limited in how they can display data, the invention allows for multiple views of the data. Each view is a complete description of the user interface including layout and content and can represent all or a subset of the available data for entry. The UI design can therefore be structured for the individual's needs: not everyone needs to see all the data in all circumstances. The view also allows the designer to control access to specific data by not including it in the view.

Therefore, views allow a powerful way to completely customize data entry not previously taught or suggested in the prior art. Once views are created, individuals are assigned to one or more views and can select the view based on their present need. An example would be a physician who uses clinical patient data to create reports for the patient chart, but also wants to be able to perform clinical trials, which require additional information to be entered at a later date. Two views are constructed: one for the clinical data and another for the research data.

### SUMMARY OF THE INVENTION

The present invention is a reporting tool built by and for physicians to produce medical reports quickly and easily without the need for dictation. One of its many strengths is the rapid way it can be deployed into any workflow without relying heavily on IT support or infrastructure.

The service of the present invention can be structured to work with a single lab or a whole hospital system. The present invention's hierarchy model is flexible enough to support almost any practice or group structure. A user can use the provided modality modules, customize them, or develop new ones.

The present invention comes complete with numerous reporting applications. If these modules do not completely fit a users' workflow, a user can change them so they do such as adding new information gathering objects, or removing ones that are unwanted; move things around on the display; or change the wording in the final report.

The present invention includes a powerful physician-designed intuitive interface where medical staff enters data at the time of the procedure or during its interpretation. The present invention allows user to review results and make changes before finalizing. Final reports are presented in a word processor, allowing the user to provide additional comments. A side-by-side report comparison feature examines data from previous reports and draft reports of the present study to be included in or contrasted with the new report. Physicians can also perform quality assurance (QA) assessments on their own interpretations or those of their colleagues. The present invention allows for scoring of multiple interpretations of a study to expedite and quantitate the QA process.

The present invention can be configured to run stand-alone, to work with other applications through interfaces or be embedded within another application as a module.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a simulated screen shot of a typical input screen for sentence generation as taught by the present invention;

FIG. 2 is a simulated screen shot of the Data Element Definition (DED) screen of the present invention;

FIG. 3 is a simulated screen shot of a report template, which is an html-based text document that contains sentence tokens used by the present invention;

FIG. 4 is a simulated screen shot illustrating the ability to upload a custom code component into the system of the present invention;

FIG. 5 is a simulated screen shot illustrating the placement of any DED or non-DED in a code template; and

FIG. 6 is a simulated screen shot illustrating a plurality of studies as well as their status information as determined by the present invention.

### DETAILED DESCRIPTION OF THE INVENTION

In the following are detailed descriptions of the invention of exemplary embodiments. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

The present invention is a reporting tool built by and for physicians to produce medical reports quickly and easily without the need for dictation. One of its many strengths is the rapid way it can be deployed into any workflow without relying heavily on IT support or infrastructure.

The present invention is generated by a software program running on a computer system and works with any web browser. To get started, an administrator creates users, groups and other administrators. The present invention comes configured for one primary user per organization or corporate entity, but any number of users performing different tasks, working in one or multiple locations, can be assigned. Thus, a user can build one lab, or set up a full hospital hierarchy.

The service of the present invention can be structured to work with a single lab or a whole hospital system. The present invention's hierarchy model is flexible enough to support almost any practice or group structure. A user can use the provided modality modules, customize them, or develop new ones.

The present invention comes complete with numerous reporting applications. If these modules do not completely fit a users' workflow, a user can change them so they do. New form objects can be defined. Existing objects can be modified, deleted or repositioned. The final report's content can be modified in the same way.

Administrators can allow individual users to access one or many different reporting applications. For example, a doctor who supervises nuclear stress testing in the morning and performs cardiac catheterizations in the afternoon can create reports in both modalities.

The present invention includes a powerful physician-designed intuitive interface where the medical staff enters data at the time of the procedure or during its interpretation. The present invention allows a user to review results and make changes before finalizing. Final reports are presented in a word processor, allowing the user to provide additional comments. A comparison feature examines data from previous reports and automatically displays clinically important changes into the new report.

The present invention has a sophisticated user-definable error-checking algorithm, reducing common errors and improving report quality and accuracy. Billing codes are verified and error checking can be changed to fit a user's needs.

The present invention is fully web-based and compliant with HIPAA (Health Insurance Portability and Accountability Act, Security Rule—Centers for Medicare & Medicaid Services (CMS) “Security Standards for the Protection of Electronic Protected Health Information,” found at 45 CFR Part 160 and Part 164, Subparts A and C), operating within a standard modern web browser.

Finally, a User Interface (including the types of information gathered, the interface elements used to gather the information, combination box, numeric input, text area, etc), containers that hold and format the display location and the concept of views) and reports consisting of sentence templates, form object fields, business logic/workflow including error checking can be fully implemented by a user without traditional programming experience, Once created, the application can be used to create reports and final results can be viewed immediately upon study completion. The user interface can be modified to work in multiple languages and localizations. Languages are considered in two parts: user interface and report generation. User interface allows substitution of different phrases based on the user's language preference. The output report language preserves the sentence construction logic inherent in the original English version, thereby simplifying translation, while allowing modifications to the sentence construction logic where language syntax and rules require different construction.

The system can be integrated with existing systems to avoid repeatedly rekeying the same data using industry-standard communication protocols, such as HL7 and DICOM. A user can also obtain statistical reports regarding how many studies were performed by a given lab or individual, or how many studies were ordered by a given doctor.

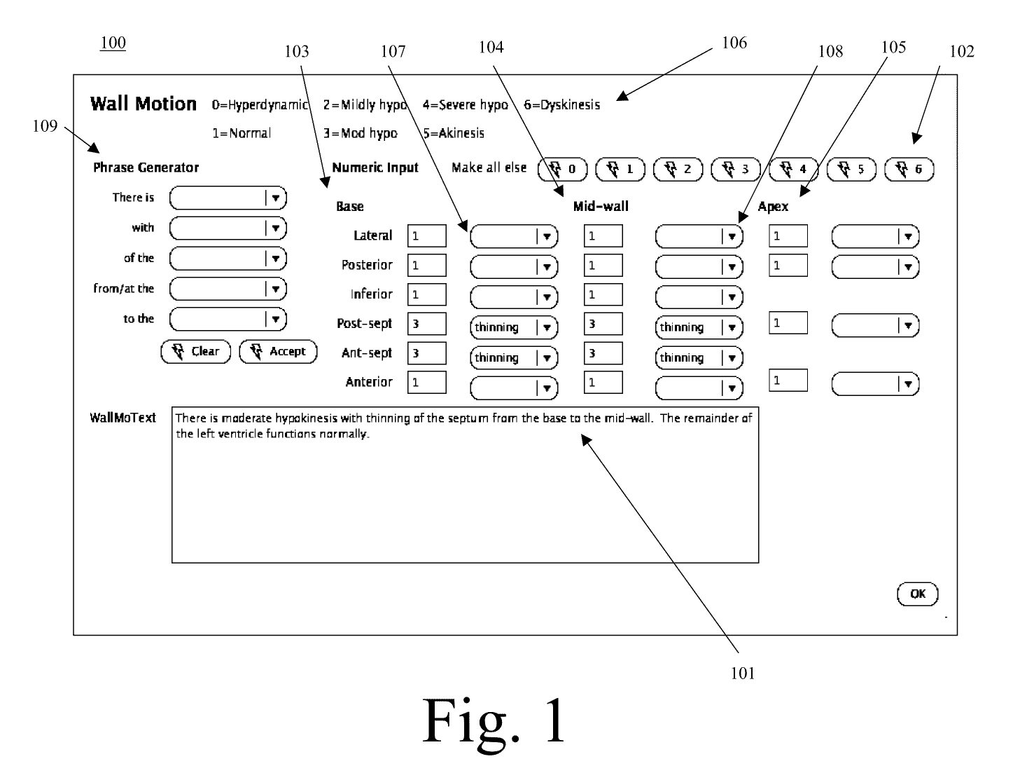

In one exemplary embodiment of the present invention, the present invention can concentrate on the wall motion phrase generator 109 as an example. Phrase generators 109 provide for creation of the text portion of a report using definable form objects to create highly variable output with minimal end-user input. For example, cardiac wall motion scoring, as shown in FIG. 1, relies on dividing the heart into segments and scoring each segment based on its motion and anatomic configuration. Typically, wall motion scoring is considered hyperdynamic (coded as “0”), normal (1), mild (2), moderate (3) or severely (4) decreased, akinetic (5) or dyskinetic (6). The heart is also typically divided into 16 or 17 segments. The segments can also have descriptions such as “thinning” “aneurysmal”, etc. Therefore, there are >33 trillion possible combinations (7 possible numeric descriptors and 16 slots). Typically, doctors must fill out all the segments manually then write a summary sentence describing the wall motion.

Wall motion abnormalities occur in coronary distribution patterns and many of the technically possible patterns are anatomically impossible, so the number of actual commentable wall motion abnormalities drops dramatically to a manageable number.

The present invention's wall motion scoring phrase generator uses the standard 16 or 17 segment wall motion scoring proposed by the American Society of Echocardiography. It divides the heart into 3-4 levels along the long axis and 4-6 segments in each level corresponding to the anterior, anteroseptal, posteroseptal, inferior, posterior, posterolateral and lateral walls. These roughly correspond to coronary anatomic descriptions, enough so that an experienced interpreter can discern with some degree of certainty, which coronary artery is diseased based solely on observations of cardiac wall motion.

The method groups adjacent structures together, so it is possible to comment upon, for example, the anterior wall alone OR the anterior and anteroseptal walls together. It is also possible to group layers (base to apex). In this way, with the selection of a few parameters, the following sentences are generated and all of the 16 segments are accurately scored: “There is severe hypokinesis with thinning of the anterior wall and anteroseptum from the base to the apex. The remainder of the ventricle is mildly hypokinetic.”

As shown in the software screen shot 100 of FIG. 1, the method of the present invention permits, with six mouse clicks, a complete description of the cardiac condition with respect to wall motion can be created. More complex wall motion scoring can also be accomplished by repeating certain operations, and generating a sentence 101 such as: “There is severe hypokinesis with thinning of the anterior wall and anteroseptum from the base to the mid-wall. There is akinesis with aneurysmal distention of the lateral wall. The remainder of the ventricle is moderately hypokinetic.”

The time reduction in commenting and the increased accuracy make this method of scoring far superior to others. The method is accomplished by using the following parameters for user input:

There is level of kinesis 106 (e.g. mildly hypokinetic)* with morphologic descriptor 107 and 108 (e.g. thinning), of the wall or walls 104 e.g. anterior wall)*, from the/at the first level (e.g. base 103) to the second level (e.g. apex 105). The description does not need to be complete. Only the two fields marked with the * are required. The method of the present invention can construct meaningful results with any other combination provided the two required fields are present. There are also straightforward ways to say the remainder of the ventricle is (normal, mildly hypokinetic, etc) using the “Make All Else” buttons 102 seen in the screen shot diagram 100. Thus, the present invention teaches a method that improves and accelerates data entry for a difficult to manage description of cardiac regional wall motion, improving speed of commentary and quality of the report.

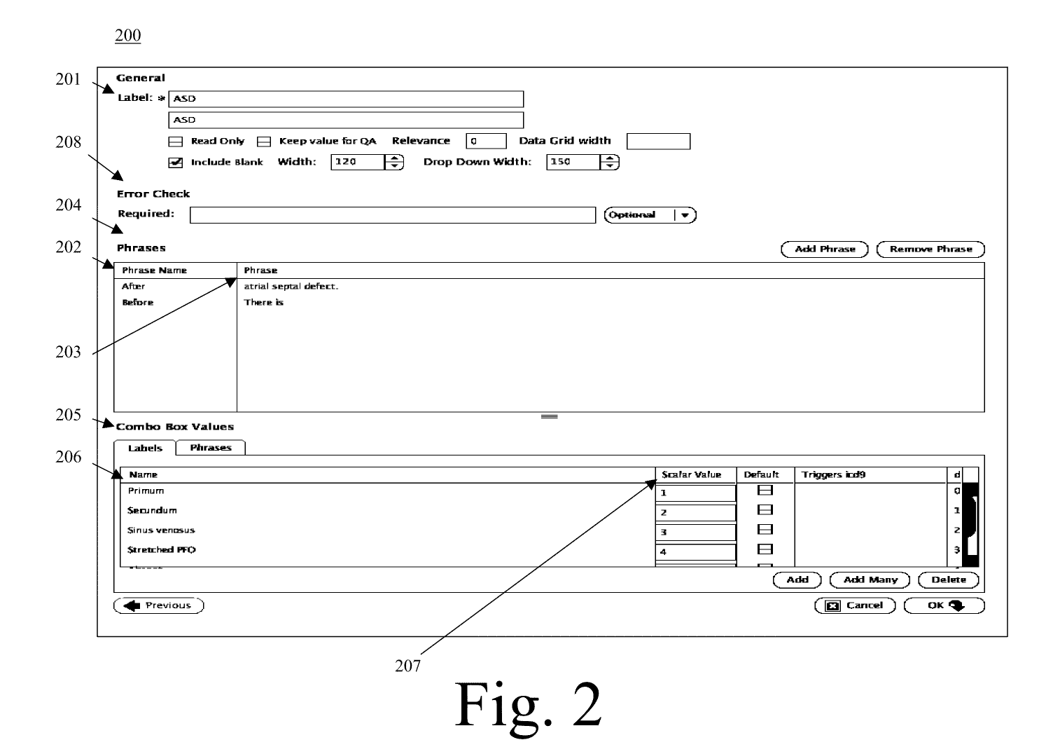

An application is a system generated by a software program running on a computer system that allows the end user to create the user interface (UI) and database schema, bind the database schema to the UI, create sentences, place those sentences in a report structure, and perform calculations and error checking 208 all without programming. Now referring to FIG. 2, the data element definition screen 200 of the user interface is shown. The data element definition screen 200 allows a user to label the data element. The user can also enter phrases 204 by adding and removing a series of phrases 204 with phrase names 202 and corresponding phrases definitions 203.

The present invention creates three types of applications: patient-based, study-based and support. A patient-based application creates and maintains data specific to a patient, but independent of a study or procedure that may be performed on a patient. A study-based application creates and maintains data specific to a study performed on a patient. A support application is independent of both patients and studies, but the data in a support application can be accessed or modified by any type of application. The present invention supports relationships between applications including one-to-many, many-to-one and many-to-many, similar to classical relational database design.

Study-based applications are part of a static workflow. The workflow starts with the modality work list, where a user's studies are listed. When the user opens a study, she sees a study tab (containing static elements about the study) and a billing tab (that allows the user assign billing procedures and billing codes to the study). The rest of the tabs are defined in the study-based application.

Support applications can be accessed directly (through a menu option) or from within other applications through different form objects, such as a data grid to represent a one to many relationship 302. An example of a support application could be an inventory database. The database holds a list of all items in stock. This list of items is managed outside of the work list when new items are received into inventory and is then used within a study-based application when the inventory is used during a study/procedure.

The present invention's sentence generation uses a sophisticated layered approach. It starts with the definition of fields and their Sentence phrases, Values and Phrase Names. These components are used in a sentence template instance (STI). These STIs are referenced as tokens 301 ($ {s:my_sentence}) that are used in the report template 300. Each type of form object has its own set of definitions (e.g. checkboxes store different information than numeric fields).

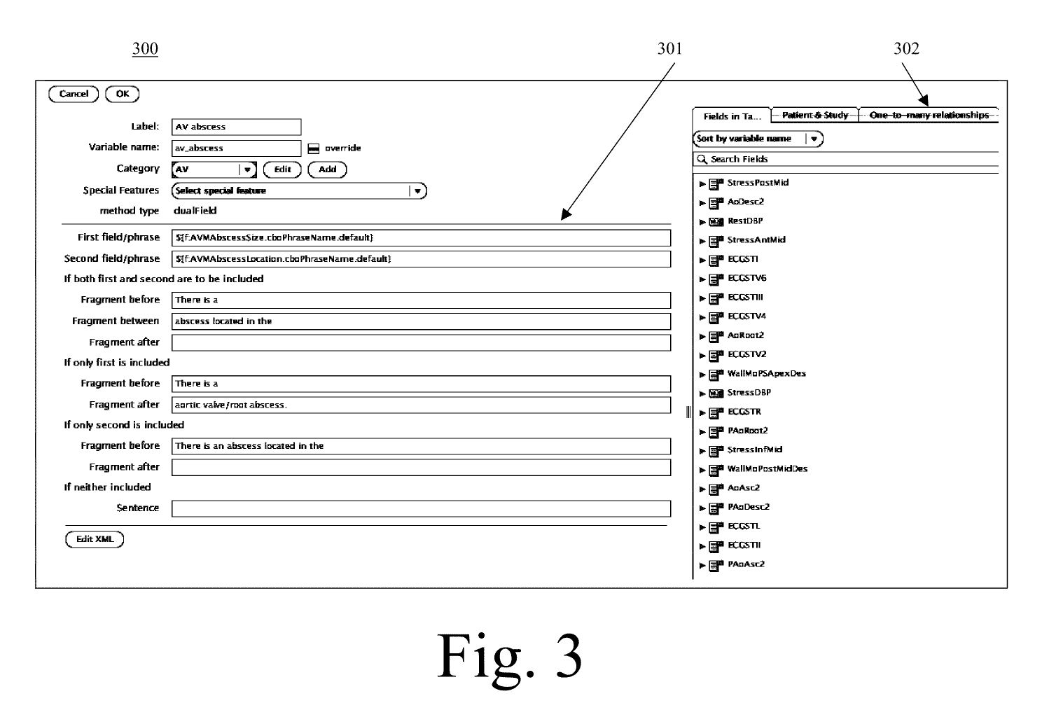

Now referring to FIG. 3, a report template 300 is an html-based text document that contains sentence tokens 301 $ {s:av_TCR}, field tokens $ {f:my_field.value} and flow control functions. Each field token can reference one of the three field components (as defined by the application). The report template 300 can also reference elements from the patient ${p:first_name}, the study ${s:date_performed}, referring physician data, attachments (files or images uploaded to the invention or captured from the user's monitor) or the billing component. Sentences and fields, graphics, tables and other formatting styles can then be placed into a report template in order to generate a report from the input data.

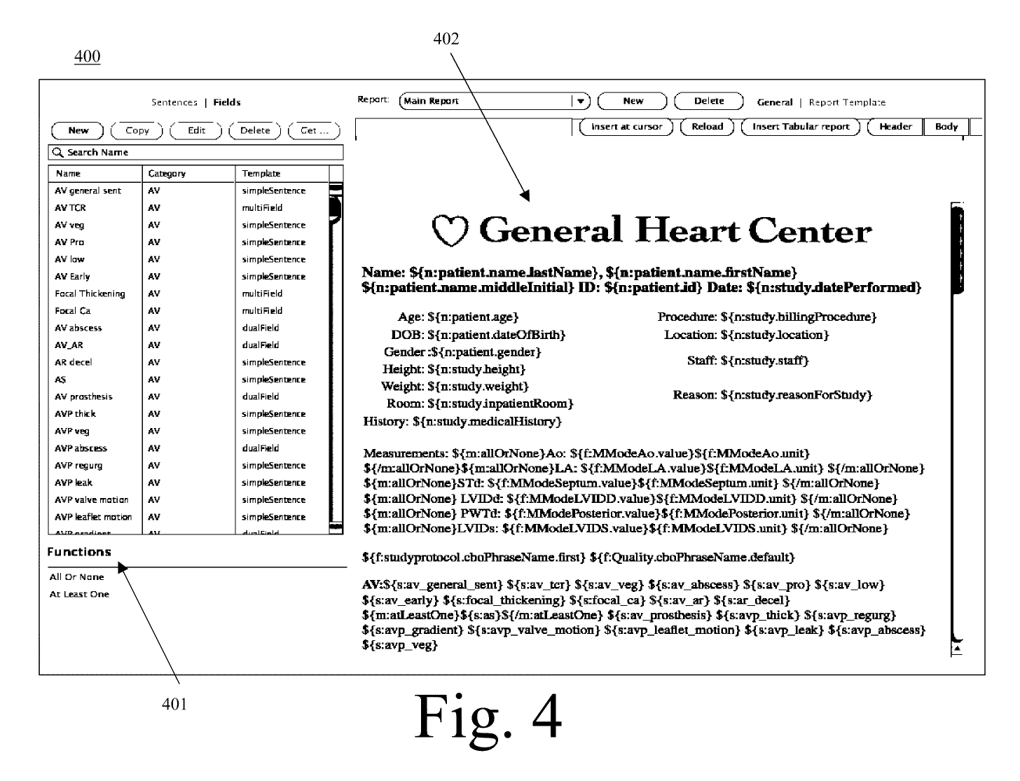

Now referring to the screen shot 400 of FIG. 4, the system has the ability to upload a custom code component 402 (as an Adobe Flash swf—ShockWave Flash-file) that is “injected” into the application at runtime. The functions 401 defined in this custom code are attached to the form objects defined in the study-based application and they are triggered by the change event of the field or the on click event of an “action button”.

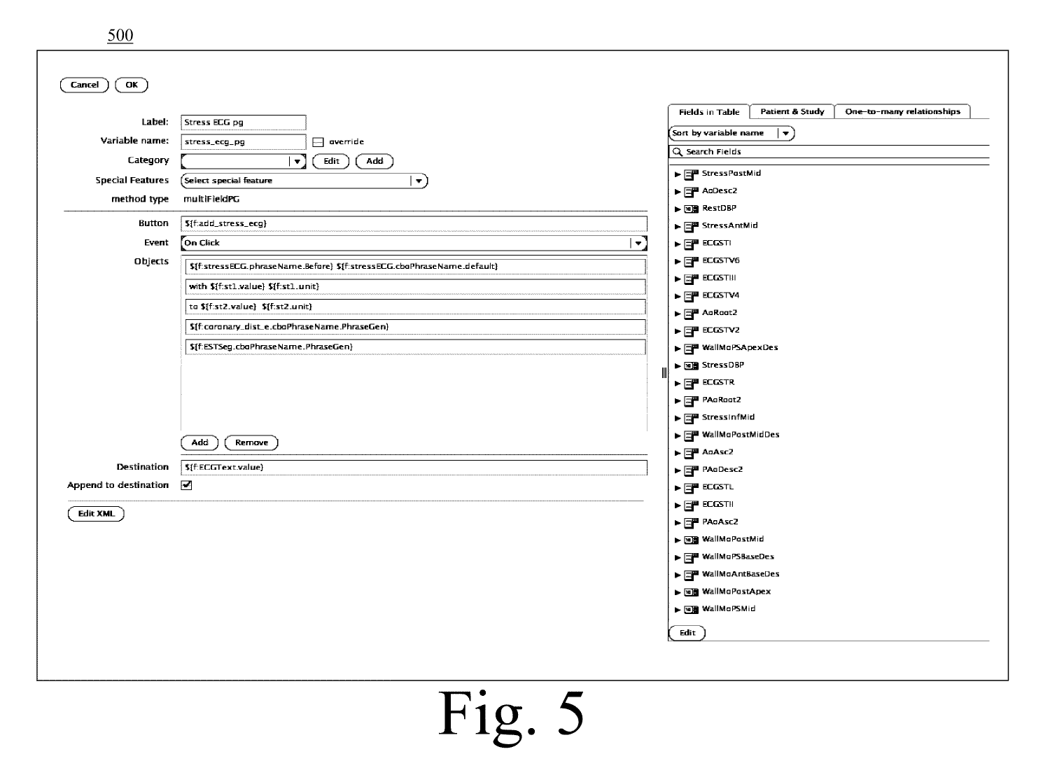

Now referring to FIG. 5, Code templates 500 allow the user to execute and reuse pre-programmed code to perform a variety of common functions or calculations. New templates can be built using a combination of XML to define the format of the template and ActionScript (part of Adobe Flash) to control the logic. Once created, the templates are reused many times.

Applications go through a development phrase and are published to become available to perform studies. The publishing strategy serializes the Java object representation of the application and moves it to the “front end” database schema.

Frequently, QA must be performed in order to maintain high standards of data interpretation. The present invention provides the ability to perform QA studies using two workflows: Prospective and Retrospective. In a prospective workflow, an expert interprets a set of studies and then assigns these studies to be interpreted by one or more people to be evaluated. In a retrospective workflow, an expert chooses a set of studies that have already been interpreted by one or more people to be evaluated and then reads each study again.

Also, the application allows for more than one interpretation on a given study/data set while keeping the data and reports separate. Since all interactions with a study by an individual are “versioned”, essentially each time a study is signed off upon by a different individual (or same individual at different times) then the QA process can start using any of the versions as a baseline.

QA scoring is accomplished by determining a difference between the gold standard study interpreted by the expert and those studies interpreted by those being evaluated. Scoring is performed on the following field types: checkboxes, combo boxes 205 and numeric fields. Each form object in an application has two fields that are relevant to QA: “Use for QA” and “relevance”. If the form object is to be used for QA, that form object/field will be used to score. The relevance value determines the importance of the field. Some fields are much more important in terms of scoring than others.

To determine the score for a given study the system must determine the number of fields to be used for scoring and sum their relevance scores—called the “basis”. For a Boolean, if an expert agrees with the evaluee, then the system must consider all of that field's relevance points. For numeric data, the system needs to determine how far off the answer is from the gold standard. These fields must have a range defined. If a numeric value can vary from 0-100, the gold standard answer is 50, while the evaluees is 70, the evaluee is off by 20/100 and will therefore receive 80% of the relevance points for that numeric comparison.

For combo boxes 205, as shown in FIG. 2 each entry or name 206 in the combo box has a scalar value 207 acing a numeric value on what are typically qualitative comparisons. A common comparison is normal, trace, mild, moderate or severe. Scalar values 207 that adjust for differences in importance of the findings are adjustable for each combo box 205: Normal=0; Trace=1; Mild=4; Moderate=10; Severe=25. If the evaluee says trace when the gold standard is normal, there is a minimal penalty (24/25 of the points awarded). However, if the evaluee says severe and its actually mild, only 4/25 of the points are awarded.

The final score is the total number of awarded points divided by the “basis” or total number of achievable points. Score ranges from 0-100%. Scores between different people evaluating the same study are compared.

Handling of null situations (applies to numeric fields and combo boxes): if the gold standard did not comment on a particular field, but the evaluee did, the QA person can decide the importance of this difference: it may be unimportant or it may be crucial. The QA person can therefore edit the final score to adjust for this situation. If the gold standard did comment on a field, but the evaluee did not, they receive no points for that field.

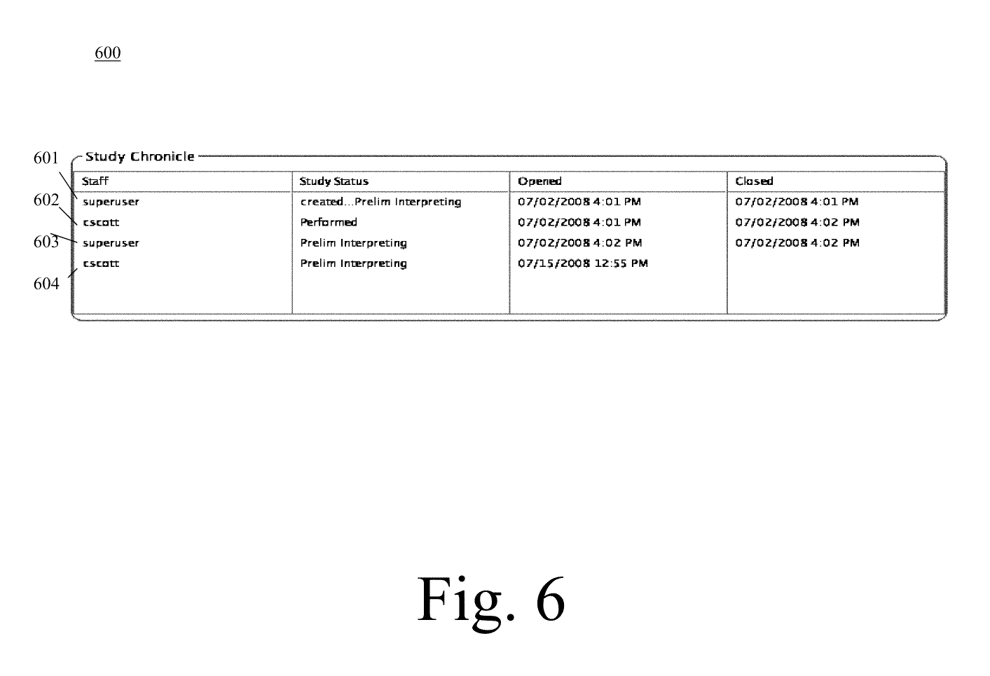

A study is saved as it moves through different stages and can be restored from any stage. Once all of the data is entered, a report is automatically generated which can then be manually edited and finalized. Every time a person saves a study, its status is assigned. A Study Chronicle provides a listing of all study versions and who created them. This workflow provides two benefits: 1) a chronological listing of the study's progress from scheduling to finished; and 2) a way to track individual additions/edits. In essence, each chronicle item 601, 602, 603, and 604 is an independent data set that can be viewed, reviewed or used as a basis of an over-read 600 as shown in FIG. 6.

Possible values for study status include: 1) Created; 2) Performed; 3) Prelim interpreting; 4) Prelim final; 5) Interpreting; 6) Finalized; 7) Edited; 8) QA Assigned; 9) QA Completed; and 10) Canceled.

A study always starts as created. This means the study has been scheduled to be performed. The performance time may be immediate or are in the future. A study must be performed once scheduled, or canceled. A preliminary status is granted to studies interpreted by junior staff (e.g. residents, fellows or technicians in the medical realm). Interpreting and Finalized statuses are reserved for users with the permission to create a final study (e.g. attending physicians in the medical realm). While the study has not be finalized (studies are saved as incomplete) the status is set to interpreting. When the study is deemed complete, the status is set to finalized. A study, once finalized, can be re-opened and changed if an update is required to the report. When the study is reopened, the finalized status is set to interpreting; when Finalized again, the status is then set to Edited.

QA allows for a study (of any status) to be re-interpreted, by the same person or another, for the purpose of validating the original interpretation or by assuming the original interpretation is a gold standard and making comparisons for testing purposes (see section on QA above). QA studies are assigned, then completed by the person to which they are assigned. A study may be canceled at any point in the process unless it has already been finalized. If canceled, the data is retained, but no report, even if one exists, is displayed.

Many programs utilize methods to control access to different individuals utilizing the same data set, most commonly by restricting access to certain forms or parts of a user interface or controlling each field to allow or deny access to the data (field is grayed out, commonly).

The present invention teaches a new method to control user access made possible through the design of the customizable UI in the present invention. The UI can be customized for each type of end user (doctor, technologist, secretary). In essence, each use can have their own version of the forms at all levels (tabs, sub forms, form objects, etc) which are called views. There is one common set of data for an application, but each view represents all or a subset of the available data for entry. The form design can therefore be structured for the individual's needs: not everyone needs to see or have access to modify all the data in all circumstances. Also, different users have different workflows so may not want to be presented with the form objects (combination boxes, numeric fields, text areas, checkboxes, etc) in the same order.

Views allow a powerful way to completely customize data entry. Once views are created, individuals are assigned to one or more views and can select the view based on their present need. An example would be a physician who uses clinical patient data to create reports for the patient chart, but also wants to be able to perform clinical trials, which require additional information to be entered at a later date. Two views are constructed: one for the clinical data and another for the research data.

Views are constructed so that some or all people may see only a part of the data while none or some people see the whole. Each successive person in a hierarchy can access all the earlier data and add new data and all people can see everything. Individuals can have a choice on how they view the data based on present need and there can also be any combination of the above.

There are several key design elements that enable the previously discussed views. The present invention allows for simultaneous creation of data storage objects and user interface items. Once created, user interface items are placed in one place or in multiple places within one or across many views. Multiple instances of the same user interface item can exist (as an alias), but only represent one actual item. Changes to one item cause immediate changes to all the other aliases. A view consists of containers and user interface items. Containers determine the formatting of the user interface. User interface items are placed within containers. Containers are nested, providing great flexibility in design. This allows the ability to place instances of user interface items into one or more views. Additionally, the present invention teaches the ability to place multiple instances of a user interface item within the same view but in a different location.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

We claim:

1. A method for medical report generation by a software program on a computer system, the method comprising the steps of:
a. creating users, user groups, and administrators;
b. providing an input interface, where users enter data at the time of the procedure or during its interpretation;
c. allowing the end user to create the UI, a database schema, data binding, sentence creation, report generation, calculations and error checking without programming;
d. providing phrase generators for creation of the text portion of a report using definable form objects to create highly variable output with minimal end-user input;
e. allowing review of the results and editing before finalizing;
f. providing a report template;
g. presenting final reports in a word processor;
h. providing a side by side comparison feature to examine data from previous reports or drafts of the present report and then display clinically important changes into the new report;
i. providing a Web-based system including application creation/modification and application use to create clinical and research reports and viewing of completed data;
j. providing statistical reports on the number of interpretations, procedures by lab, individual, ordering doctor or by billing information;
k. generating quality assurance scores; and
l. providing studies of generated reports.

2. The method for medical report generation by a software program on a computer system of claim 1 further comprising one primary user per organization or corporate entity.

3. The method for medical report generation by a software program on a computer system of claim 2 wherein a plurality of users performing different tasks, working in one or more locations, can be assigned.

4. The method for medical report generation by a software program on a computer system of claim 1 further comprising one lab or set a full hospital hierarchy or one or more labs.

5. The method for medical report generation by a software program on a computer system of claim 4 further comprising the steps of:
m. providing a user with modality modules;
n. allowing a user to customize the provided modality modules; or
o. allowing the user to develop new modality modules.

6. The method for medical report generation by a software program on a computer system of claim 1 wherein a user can change the reports to fit a users' workflow by defining new form objects and modifying existing objects by deletion or reposition, and defining a final report's content by defining new form objects and modifying existing objects by deletion or reposition.

7. The method for medical report generation by a software program on a computer system of claim 1 wherein an administrator allows individual users access to one or more different reporting applications.

8. The method for medical report generation by a software program on a computer system of claim 1 further comprising:
p. providing a sophisticated user-definable error-checking algorithm, reducing common errors and improving report quality and accuracy; and
q. providing editable billing code verification and error checking determined by a user's needs.

9. The method for medical report generation by a software program on a computer system of claim 1 further comprising:
r. providing a wall motion scoring phrase generator using the standard 16 or 17 segment wall motion scoring proposed by the American Society of Echocardiography;
s. dividing the heart into 3-4 levels along the long axis and 4-6 segments in each level corresponding to: for the 16 segment model: the anterior, anteroseptal, posteroseptal, inferior, posterior, posterolateral and lateral walls, and for the 17 segment model, the anterior, anteroseptal, inferoseptal, inferior, inferolateral and anterolateral walls;
t. grouping adjacent structures together, so it is possible to comment upon a wall alone or two or more walls together;
u. grouping layers base to apex; and
v. combining a selection of groups and parameters to automatically generate sentences resulting in the scoring of all 16 segments.

10. The method for medical report generation by a software program on a computer system of claim 9 wherein the following parameters are used to generate meaningful results in sentence format from user input from at least any two of the following fields:
level of kinesis;
morphologic descriptor;
location; and
from a first level to a second level.

11. The method for medical report generation by a software program on a computer system of claim 1 further comprising:
an application in the computer system that allows the end user to create the user interface and database schema, bind the database schema to the user interface, create sentences, place those sentences in a report structure, and perform calculations and error checking all without programming.

12. The method for medical report generation by a software program on a computer system of claim 11 wherein;
the user interface can be customized for each type of end use;
each user can have their own version of the forms at all levels including tabs, sub forms, and form objects, which are called views;
there is one common set of data for an application, but each view represents all or a subset of the available data for entry;
the form design can therefore be structured for the individual's needs;
once views are created, individuals are assigned to one or more views and can select the view based on their present need’
views are constructed so that none, some or all people may see only a part of the data while none, some or all people see the whole;
each successive person in a hierarchy can access all the earlier data and add new data and all people can see everything; and
individuals can have a choice on how they view the data based on present need and there can also be any combination of the above.

13. The method for medical report generation by a software program on a computer system of claim 12 wherein;
simultaneous creation of data storage objects and user interface items is allowable;
once created, user interface items are placed in one place or in multiple places within one or across many views;
multiple instances of the same user interface item can exist (as an alias, but only represent one actual item;
changes to one item cause immediate changes to all the other aliases;
a view consists of containers and user interface items;
containers determine the formatting of the user interface;
user interface items are placed within containers;
containers are nested, providing the ability to place instances of user interface items into one or more views, or multiple instances of a user interface item within the same view but in a different location.

14. The method for medical report generation by a software program on a computer system of claim 13 wherein three types of applications: patient-based, study-based and support are generated;
said patient-based application creates and maintains data specific to a patient, but independent of a study or procedure that may be performed on a patient;
said study-based application creates and maintains data specific to a study performed on a patient; and
said support application is independent of both patients and studies, but the data in a support application can be accessed or modified by any type of application.

15. The method for medical report generation by a software program on a computer system of claim 14 wherein relationships between applications include one-to-one, one-to-many, many-to-one and many-to-many.

16. The method for medical report generation by a software program on a computer system of claim 13 wherein sentence generation uses a sophisticated layered approach wherein:
starting with the definitions of fields and their sentence phrases, values, and phrase names;
sentence phrases, values, and phrase names are used in a sentence template instance;
sentence template instances are referenced as tokens that are used in the report template;
and;
each type of form object has its own set of definitions;
a report template is an html-based text document that contains sentence tokens, field tokens, and flow control functions;
each field token can reference one of the three field components as defined;
the report template also references elements from the patient, the study, referring physician data, attachments or the billing component; and
sentences and fields, graphics, tables and other formatting styles can then be placed into a report template in order to generate a report from the input data.

17. The method for medical report generation by a software program on a computer system of claim 1 further comprising the step of uploading a custom code component that is injected into the application at runtime; the functions defined in this custom code are attached to the form objects defined in the study-based application and they are triggered by the change event of the field or the on click event of an action button.

18. The method for medical report generation by a software program on a computer system of claim 1 further comprising the step of allowing the user to execute and reuse pre-programmed code to perform a variety of common functions or calculations.

19. The method for medical report generation by a software program on a computer system of claim 1 further comprising the step of performing quality assurance studies.

20. The method for medical report generation by a software program on a computer system of claim 19 wherein the quality assurance studies are performed using two workflows: Prospective and Retrospective;
in a prospective workflow, an expert interprets a set of studies and then assigns these studies to be interpreted by one or more people to be evaluated;
in a retrospective workflow, an expert chooses a set of studies that have already been interpreted by one or more people to be evaluated and then reads each study again.

21. The method for medical report generation by a software program on a computer system of claim 20 wherein all interactions with a study by an individual are versioned allowing more than one interpretation on a given study/data set while keeping the data and reports separate.

22. The method for medical report generation by a software program on a computer system of claim 21 wherein:
scoring is accomplished by determining a difference between the gold standard study interpreted by the expert and those studies interpreted by those being evaluated;
scoring is performed on the following field types: checkboxes, combo boxes and numeric fields
assigning each form object in an application has two fields that are relevant, if the form object is to be used for QA, that form object/field will be used to score;
calculating the relevance value determines the importance of the field;
determining the number of fields to be used for scoring and sum their relevance scores—called the “basis”;
for a Boolean, if an expert agrees with the evaluee, then the system must consider all of that field's relevance points'
for numeric data, the system needs to determine how far off the answer is from the gold standard,
these fields must have a range defined,
if a numeric value can vary from 0-100;
for combo boxes, each entry in the combo box has a scalar value placing a numeric value on what are typically qualitative comparisons,
a common comparison is normal, trace, mild, moderate or severe;
scalar values that adjust for differences in importance of the findings are adjustable for each combo box: Normal=0; Trace=1; Mild=4; Moderate=10; Severe=25,
if the evaluee says trace when the gold standard is normal, there is a minimal penalty,
if the evaluee says severe and its actually mild, only partial points are awarded; and
calculating the final score is the total number of awarded points divided by the basis or total number of achievable points.
